(19) United States
(12) Patent Application Publication
(10) Pub. No.: US 2006/0288332 A1
(43) Pub. Date: Dec. 21, 2006

(54) Workflow debugger

(75) Inventors: Akash J. Sagar, Redmond, WA (US); Aditya G. Bhandarkar, Redmond, WA (US); Dennis Pilarinos, Redmond, WA (US); Dharma K. Shukla, Sammamish, WA (US); Mayank Mehta, Redmond, WA (US); Sergey Chub, Redmond, WA (US); Vishal Kalra, Redmond, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/157,619

(22) Filed: Jun. 21, 2005

(51) Int. Cl. G06F 9/44

(52) U.S. Cl. 717/124

(57) ABSTRACT

Workflow debugging. A debug engine integrated with an external development tool debugging framework sets breakpoints directly on workflow activities and stops execution of the workflow at each of the breakpoints. The state of the workflow activity at the breakpoint is displayed. The debug engine extracts source code of the workflow for debugging at the source code level.

### BACKGROUND

Debugging usually involves the use of a debugger tool, which allows a user to observe the run-time behavior of a program and analyze logical errors and the like in the program. Development tools, such as Visual Studio® available from Microsoft Corporation, often include debugger tools.

One known debugging technique involves inserting a breakpoint to signal the debugger to temporarily suspend execution of the program at a certain point. Rather than stepping through code line-by-line or instruction-by-instruction, the user allows the program to run until it hits a breakpoint, then starts to debug. When the program it halted at a breakpoint (i.e., in break m ode), the user can examine local variables and other relevant data without inserting additional calls to output the values. The break mode usually allows the user to adjust the program by changing values of variables, moving execution points, and, in some instances, changing the code itself. In general, the debugger has a debugger interface for setting breakpoints.

Unfortunately, conventional debuggers are inadequate for debugging workflows. Workflow applications often model business processes carried out over relatively lengthy periods of time and include forms routing/approval, document review/publishing, issue tracking, and the like. A typical workflow process is made up of a series of tasks and events, the order in which they must occur, and the script that is executed for each event. In general, a workflow process automates and enforces the order of tasks. For example, a user can create a new item in a folder and assign it to another user. This other user can resolve the item and assign it to the original user who then can close the issue. Because developing a workflow is usually a complex process involving many components in the system, a very important part of the development process is the ability to run the workflow and debug it to identify and fix problems.

### SUMMARY

Embodiments of the invention overcome one or more deficiencies in known systems by permitting debugging directly within development tools in both workflow designer and the underlying code views. As such, aspects of the invention significantly reduce development time. In one embodiment, the invention allows invasive debugging of workflows along with user code to accomplish improved debugging. Moreover, aspects of the invention extend the debugging concepts of state inspection, breakpoints, stepping, watches, etc. to the workflow level.

Computer-readable media having computer executable instructions for debugging workflows embody further aspects of the invention. Alternatively, embodiments of the invention may comprise various other methods and apparatuses.

Other features will be in part apparent and in part pointed out hereinafter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating exemplary computer architecture for implementing aspects of the invention.

FIG. 2 is an exemplary debugger threads window according to aspects of the invention.

FIG. 3A is an exemplary debugger call stack window according to aspects of the invention.

FIGS. 3B and 3C are exemplary user interface visualizations of primitive and composite activities with call stack entry selected, respectively, according to aspects of the invention.

FIG. 3D is an exemplary user interface visualization of a composite activity with previous call stack entry selected according to aspects of the invention.

FIGS. 4A and 4B are exemplary debugger breakpoint windows according to aspects of the invention.

FIGS. 4C and 4D are exemplary user interface visualizations of primitive and composite activities with breakpoint set, respectively, according to aspects of the invention.

FIG. 5 is an exemplary user interface visualization of a workflow execution state according to aspects of the invention.

FIG. 6A is an exemplary flow diagram illustrating step-over behavior according to aspects of the invention.

FIG. 6B is an exemplary user interface visualization of workflow with stepping according to aspects of the invention.

FIG. 7 is a block diagram illustrating an exemplary embodiment of a suitable computing system environment in which an embodiment of the invention may be implemented.

Corresponding reference characters indicate corresponding parts throughout the drawings.

### DETAILED DESCRIPTION

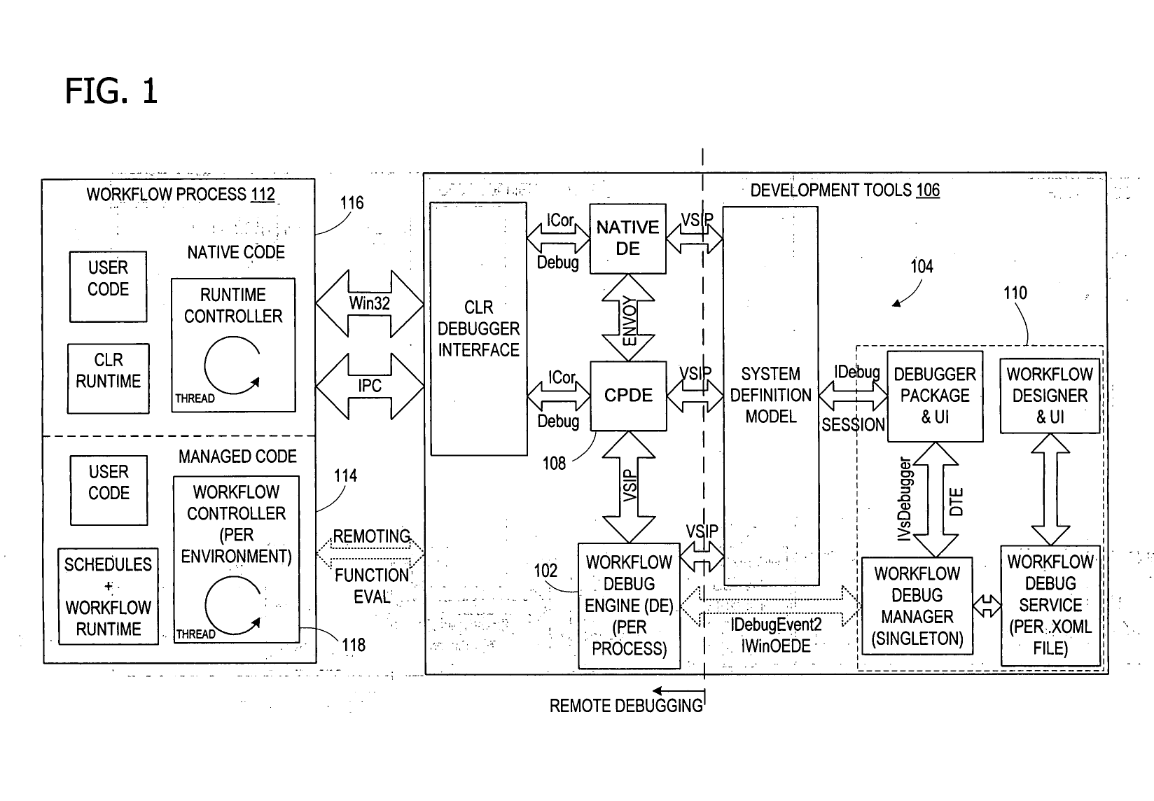

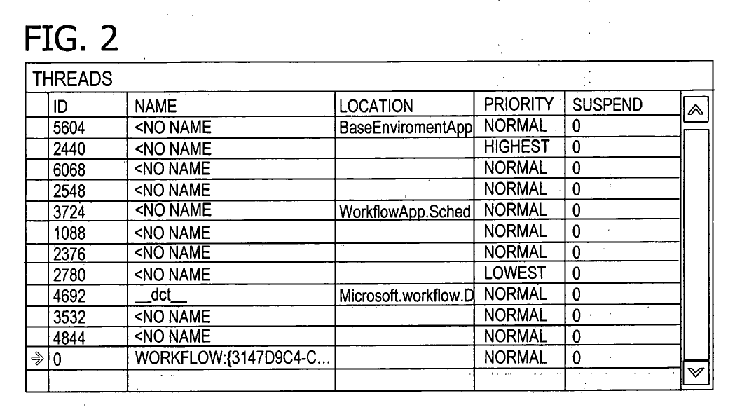

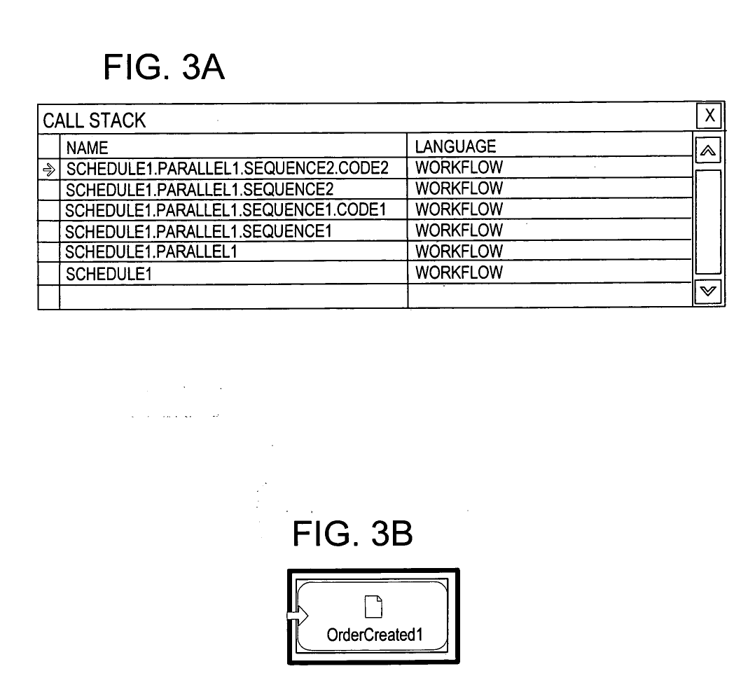

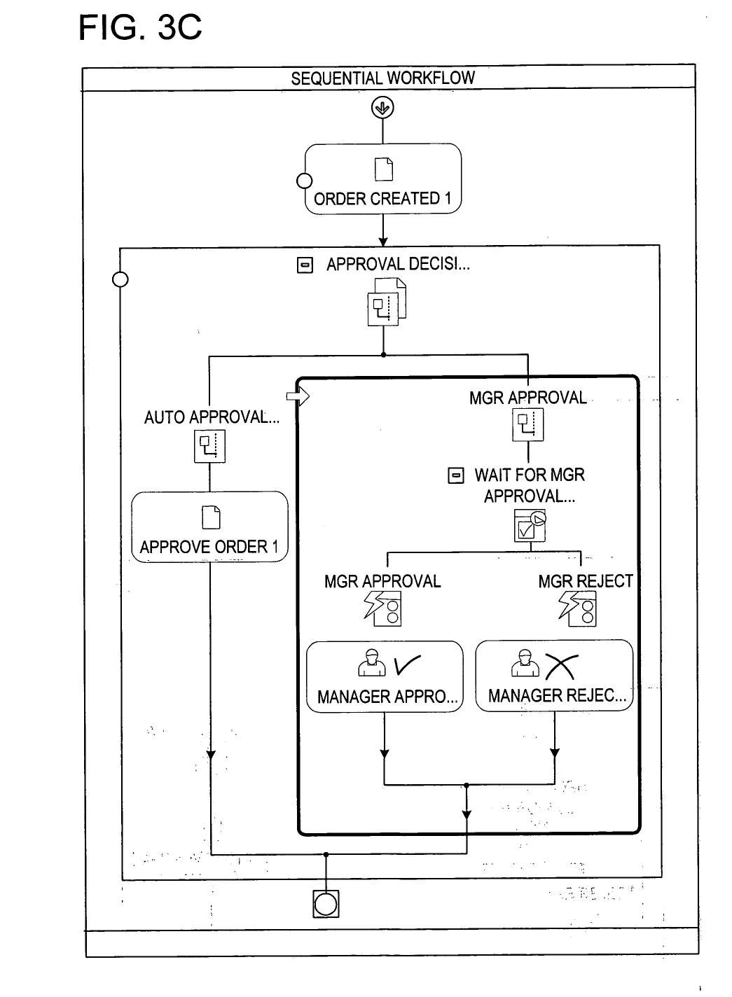

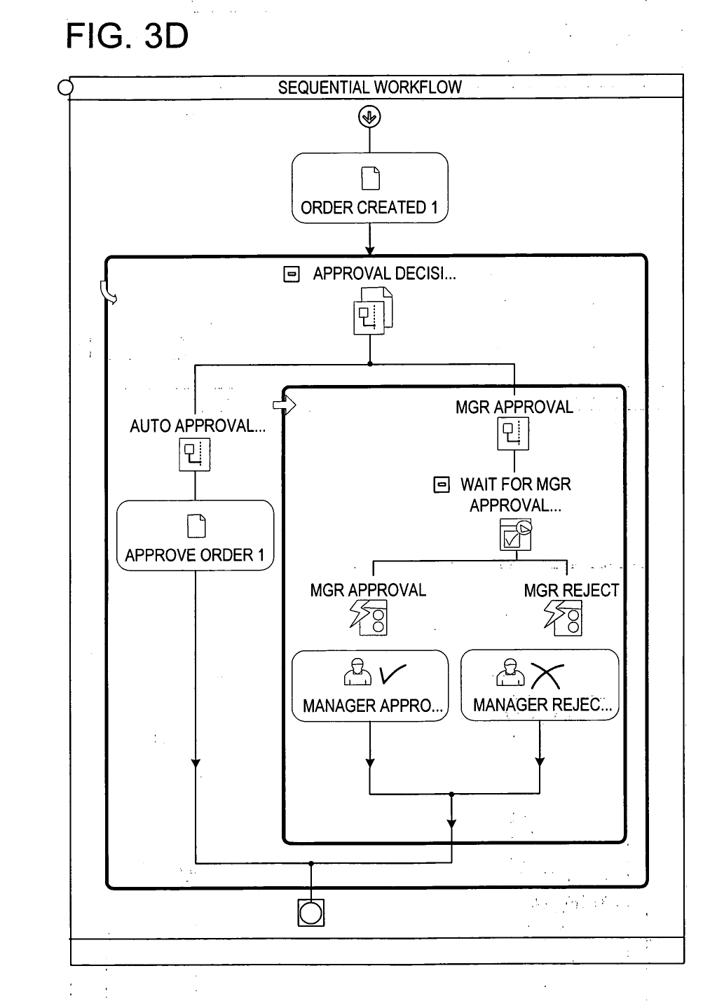

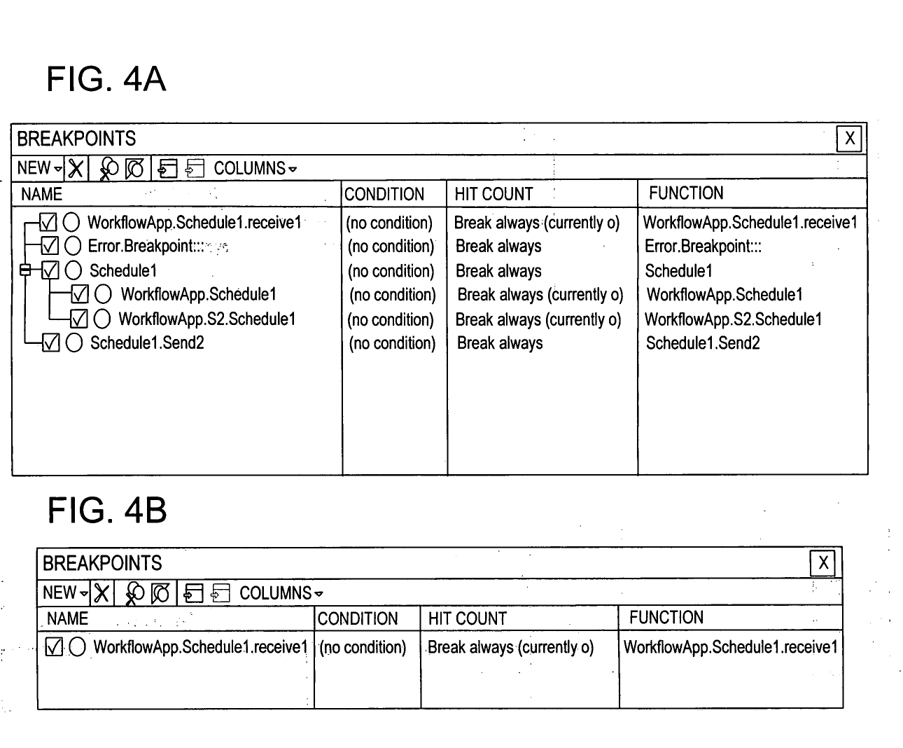

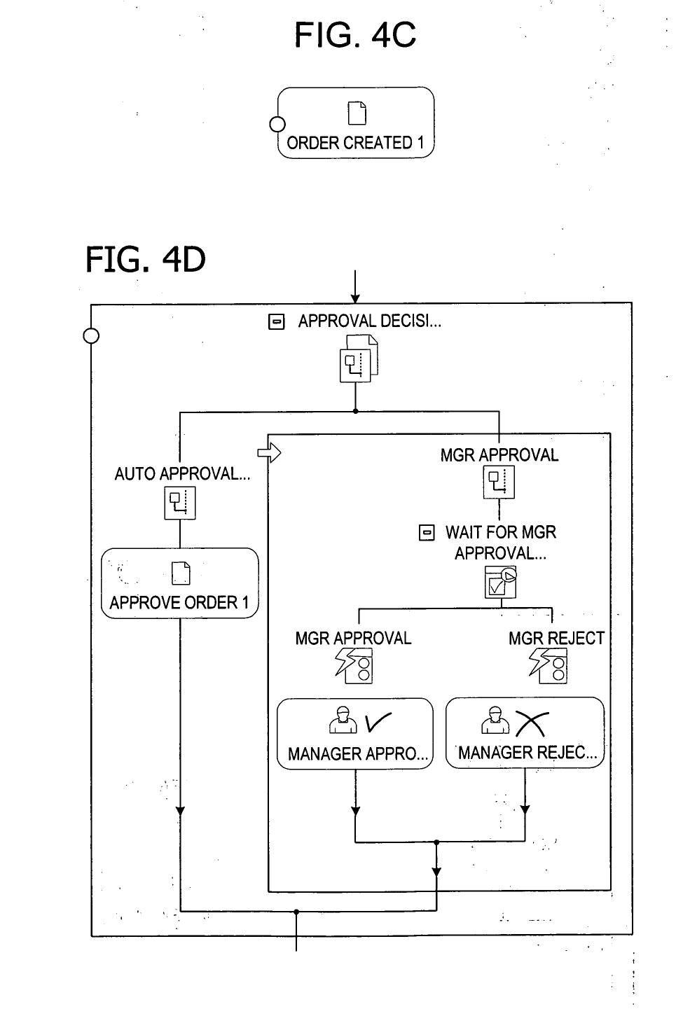

Referring now to the drawings, FIG. 1 illustrates exemplary computer architecture for implementing aspects of the invention in block diagram form. As shown, a workflow debugger, or debug engine, 102 is integrated with an external debugging framework 104. In one embodiment, a suite of development tools 106, such as Visual Studio® available from Microsoft Corporation, provides a suitable framework for debugging generally. The workflow debug engine 102 layers on top of a managed debugging generally 108 provided by the framework 104 in the illustrated embodiment. In this manner, debug engine 102 is an invasive tool for debugging workflows created by a workflow design tool 110. Moreover, layering the workflow debug engine 162 leverages functionality from the managed debug engine 108 and allows for interoperability between debugging workflows and debugging source code (e.g., C#, Visual Basic® computer program available from Microsoft Corporation, native source code, etc.). In addition, embodiments of the present invention are integrated with existing debugging tools windows, such as a breakpoint window (see FIG. 4A), a call stack window (see FIG. 3A), a thread window (see FIG. 2), locals and a watch window (not shown).

The user interacts with computer-executable components to create a workflow, indicated at reference character 112, including a serialized representation in a language such as an extensible object markup language (XOML). A compiler component 114 may generate the assembly (e.g., from generated code, XOML, and/or code-beside) and a runtime component 116 may execute the assembly. In one embodiment, the compiler component 114 includes a debug controller 118, described below.

According to the exemplary architecture of FIG. 1, the user may, via the workflow debugger 102, launch the debuggee process (i.e., the workflow 112) or attach to a running process (i.e., the executable that will be attached to by the debugger). Once attached, the user may view all of the running and suspended workflow instances in the workflow designer 110. If the source (e.g., XOML) file of the workflow 112 is not available or is out of date, the debugger 102 is able to extract the markup of the workflow from the running instance and show the markup in the designer 110. In other words, workflow 112 may be displayed in the debugger 102 even when the source files are not present. This is referred to as the XOML Live view. Workflows that have undergone dynamic updates (i.e., that have been modified at runtime) may also be displayed using the so-called XOML Live view for displaying the current activities that exist in them. The debugging operations, such as inspection, breakpoints, and stepping, are fully supported in the XOML Live view of the workflow. As such, embodiments of the invention provide seamless debugging at the source code level as well as at the workflow level. Moreover, the workflow 112 may be displayed in the debugger 102 for code-only workflows and debugging may be accomplished for workflow activities written by third party developers without extra code needed by the third party developer.

In one embodiment of the invention, workflow debug engine 102 permits a user to set breakpoints (with conditions) on workflow activities. Those skilled in the art are familiar with the use of breakpoints to signal debugger 102 to temporarily suspend execution of a program at a certain point. Entering the break mode when execution is suspended at a breakpoint does not terminate or end execution of the program. Rather, execution can be resumed or continued at any time. During the break mode, the user may examine the states of various activities and variables of workflow 112 for bugs. Also, the user may change the value of a variable, for example, or make other changes to rectify any identified errors in the break mode. According to aspects of the invention, breakpoints are not part of the actual source code. Thus, breakpoints, unlike a “stop” statement in source code, can be deleted or changed without having to change the program's source code. With breakpoints, the user can select and disable or enable any or all of the breakpoints from the breakpoint window (see FIG. 4A).

In one embodiment of the invention, breakpoints may also be set based on hit counts. Once a breakpoint is hit, the debugee process 112 (i.e., the workflow) is stopped to allow the user to inspect it. The “hit count” allows the user to determine how many times the breakpoint has been hit before debugger 102 breaks execution. By default, debugger 102 breaks execution every time the breakpoint is hit. The user can set a hit count to tell the debugger 102 to break every n times the breakpoint is hit. As an example, “hit counts” provide useful information when bugs do not appear the first time a program executes a loop, calls a function, or accesses a variable.

In an alternative embodiment, breakpoints may be set for specific activity state changes. Moreover, by integrating with the external debugging framework 104, embodiments of the invention also offer data breakpoints set on global or local variables, rather than at locations in the code. Setting a data breakpoint causes execution to break when the value of that variable changes.

Aspects of the present invention also permit the user to perform stepping operations on workflow 112 at the workflow activity level: Stepping operations include, for example, stepping over, in, and out of activities, and performing a “run to activity”. Advantageously, one embodiment of the invention also allows stepping from the workflow designer 110 to a code handler for activities as well as stepping out of the handlers back to the designer. In other words, the user may step into business logic from the process logic, and vice-versa. In this embodiment, the user code may be either C# or Visual Basic® available from Microsoft Corporation.

In an alternative embodiment, the user, via designer 110, has the option of preventing debugger 102 from stepping to activities that begin executing outside the currently executing context of a composite activity. For example, all the activities within the branch of a parallel would be stepped to even if an event handler activity begins executing when this option is selected. This option also allows the user to choose which branch of the parallel to step into (e.g., by double clicking on the call stack).

APPENDIX A illustrates aspects of the invention in a walkthrough of an exemplary debugging scenario.

According to aspects of the invention, a user (e.g., the workflow developer) selects a process 112 through the development tools 106 to be debugged. For example, development tools 106 may present a list including processes running workflow hosts from which the user can select the desired process and set the type of code to Workflow to instantiate the workflow debug engine 102.

Embodiments of the invention provide a number of Debugger Tool Windows that the workflow developer either integrates with or creates via designer 110. Referring now to FIG. 2, an exemplary debugger threads window lists all of the in memory instances of workflow types within the process 112. The format of the listing in this example is “Workflow: {InstanceIDGuid}”.

In FIG. 3A, an exemplary workflow debugger call stack window according to aspects of the invention modifies a traditional call stack window (CSW) to provide a list of the activities in a schedule that were executing at the time the breakpoint was hit. The entries in the call stack window are a hierarchical depth first ordering list of executing activities. For example, double Clicking on an entry in the CSW navigates to the corresponding designer 110 (or opens a new designer if there is no designer opened for the given workflow type or the instance has been dynamically modified) and places focus on the selected activity. This functionality is also accessible by selecting the “Go to Source Code” context menu. The call stack window displays the depth first ordering of executing activities when the development tools have the workflow instance selected in the Threads window. If a breakpoint hit was set in another editor (e.g., the C# code editor) or the user has changed to a thread executing another language (e.g. C#), the call stack window changes to display the call stack of the corresponding debug engine 102. Call Stack Context Menu options may include one or more of the following: copy, select all, switch to frame, go to source code, unwind to this frame, hexadecimal display, include calls to/from other threads, and symbol settings.

FIGS. 3B and 3C are exemplary user interface visualizations of primitive and composite activities with call stack entry selected, respectively, according to aspects of the invention. FIG. 3D is an exemplary user interface visualization of a composite activity with previous call stack entry selected according to further aspects of the invention. Visual Integration with the call stack is signaled to the developer by providing, for example, a yellow arrow and highlight (shown in bold in FIGS. 3C and 3D) around the activity that has been selected in the call stack window. When an entry below the top of the stack is selected, it may be highlighted in green (shown in bold in FIGS. 3C and 3D) consistent with other implementations of Debug Engines and Source Editors.

Referring now to FIGS. 4A and 4B, exemplary debugger breakpoint windows are shown to illustrate aspects of the invention. As described above, a breakpoint in the context of a workflow is a location in code that, when reached, triggers a temporary halt in an application. Developers use breakpoints to test and debug programs by causing the program to stop at scheduled intervals so that the status of the program can be examined in stages. The breakpoint experience exposed by the code editors is still intact and a developer may set a breakpoint in the code and expect the workflow execution to halt at that point.

However, the workflow designer 110 allows breakpoints to be set visually within a workflow on activities. Breakpoints are set on activities, for example, in the following ways: select the activity and choose “Set Breakpoint” from the workflow menu; context menu right click and choose “Set Breakpoint”; and press “F9” while an activity is selected. After a breakpoint has been hit, the breakpoint window of FIG. 4A appears.

If a developer wishes to add another breakpoint, he or she may do so by selecting the “New” button and choosing “Break at Function . . .”. This invokes a “New Breakpoint” window.

The syntax that describes a valid breakpoint may be, for example, as follows:

[Namespace.]DataContextId[.ActivityId][:[InstanceId][:Status]]

There are three types of breakpoints according to embodiments of the invention: Pending, Bound and Error. When a developer specifies a breakpoint in the “Function” text box in the dialog above, he or she is actually defining a “Pending” breakpoint. When a developer adds a Pending breakpoint it is added to the Breakpoint Window and potentially bound. “Pending” breakpoint is a name for a source breakpoint. When the debug engine 102 attaches to a process (e.g., process 112), it tries to map source level breakpoints to code breakpoints. The source breakpoints that were mapped successfully change to bound breakpoints. There may be several bound breakpoints (e.g., if there are activities with the name in several workflow types). The source breakpoints that were not mapped yet, either because the workflow type is not loaded yet or there was an error in the syntax, will become error breakpoints. A breakpoint to be bound adheres to the format defined above and is an activity within the schedule. The successful binding of a breakpoint is represented, for example, by a breakpoint changing from hollow red (Pending) to a solid red icon (Bound).

Binding occurs after the runtime has loaded a workflow type. In one embodiment, when a workflow instance changes dynamically, the debugger treats it as having a new type. Breakpoints may be bound to all workflow types that match the specified breakpoint syntax. As expected, a Bound breakpoint would cause execution to halt at the specified breakpoint. The “WorkflowApp.Schedule1.receive1” breakpoint shown in the example of FIG. 4B is a bound breakpoint. If not specified, the InstanceID is not used as part of the binding process. Binding occurs against types, not instances. However, the breakpoint with instance ID specified would cause execution to halt for a workflow with that InstanceID; otherwise it would cause execution to halt in all instances of the type that the breakpoint was bound to. The same is true for Status. If the activity status is not specified, the activity will break on entering the executing state.

There are some implications of this behavior. Consider a scenario where the assembly house two workflows each with their own namespace, however, both workflows are called Schedule1. If the developer specifies a breakpoint to be set on “Schedule1”, then breakpoints will be set on both types and be represented as a tree in the breakpoints window. The parent node represents the pending (source level breakpoint) and each child node of the tree represents the location of a matching bound (code level) breakpoint (see FIG. 4B “Schedule1” breakpoint). If a developer adds a breakpoint that follows the syntax, but the breakpoint has not been bound yet, the breakpoint may be adorned with an icon which indicates that it is an error breakpoint (e.g., Schedule1.Send2)

Embodiments of the invention include one or more of the following breakpoint functionalities: hit count, when hit, language (e.g., constant value of ‘Workflow’ for workflow specific breakpoints), function (e.g., for error and pending breakpoints, whatever the user typed; for bound breakpoints, namespace qualified activity ID such as WorkflowApp.Schedule.code2), file (e.g., for bound breakpoints, a location within XOML where “breakpoint” activity resides), and location (e.g., for bound breakpoints, information such as [Namespace.]DataContextId[.ActivityId][:[InstanceId][:Status]]).

In one embodiment, there are seven context menus available in the breakpoints window. Breakpoint context menu options may include one or more of the following: location (e.g., allows a developer to rename the selected a new breakpoint), condition, hit count, when hit, delete, and go to source code (e.g., for bound breakpoints, navigates the designer and places focus on the activity on which the breakpoint is set).

FIGS. 4C and 4D illustrate an exemplary developer's user experience with respect to setting breakpoints as it applies to the “debugger mode” of the designer 110. When a breakpoint has been set, an activity may be adorned with the breakpoint icon to the left of the activity. FIGS. 4C and 4D are exemplary user interface visualizations of primitive and composite activities with breakpoint set, respectively, according to aspects of the invention.

Referring now to a watch window, this window allows a developer to add watches on properties of activities within the workflow 112. These properties will be correctly evaluated only if it is exposed by the currently selected activity in the call stack. The properties which will be displayed in this window are the same as those seen if debugging in C# and used in the watch window. To add watches on members of the Datacontext, the developer adds a watch called “$DataContext” and expands to view the properties and variables of interest.

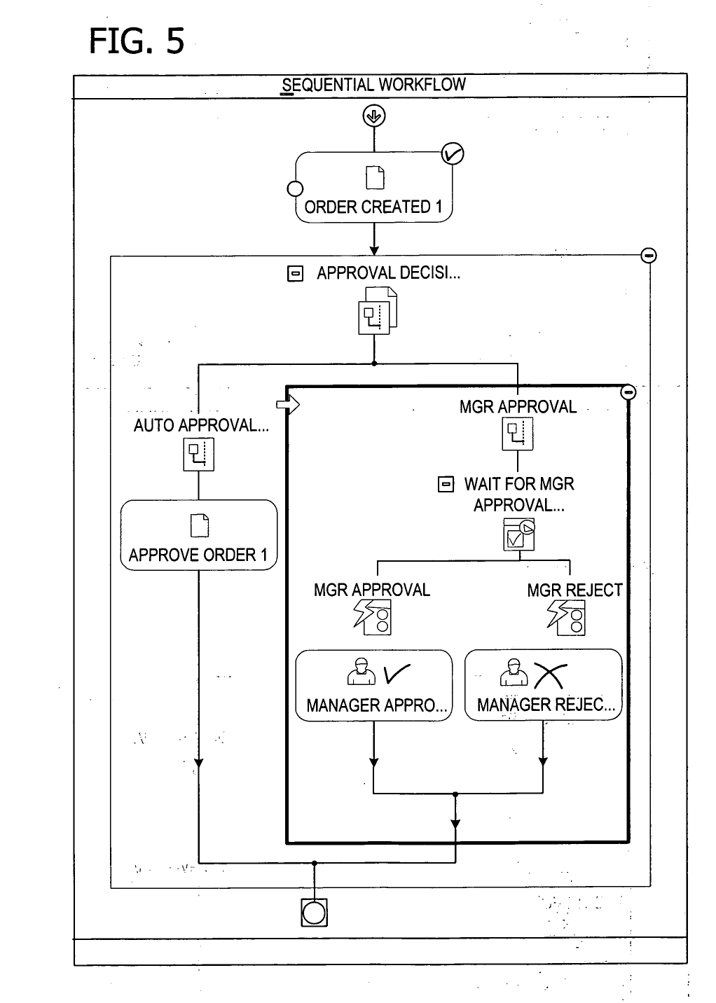

FIG. 5 shows a debugger UI visualization of an execution state according to an embodiment of the invention. The visualization illustrates the developer's experience as it applies to the “debugger mode” of the designer 110. As the workflow 112 executes, a subset of activity's state may be reflected in designer 110 by enabling “Show Execution State” (via Context Menu and Tools Menu). This subset in the illustrated embodiment consists of Completed and Executing. An, activity that has completed execution may be adorned with a “check mark”. An activity that is currently executing may be adorned with a “Play” icon.

Referring now to the stepping functionality embodied by aspects of the invention, there are three stepping operations supported by the debugger 102, namely, stepping in, stepping out, and stepping over. Because of the parallel nature of workflow, stepping is significant given a “stepping context”. This context can be derived by interpreting the selection in the call stack window and factoring out the contents of the call stack window into “branches”. The algorithm is as follows: starting at the bottom of the call stack move up continually matching each succeeding context (where a context is the string between two dots). The point where the previous context changes is the boundary between two branches.

The expected behavior of “stepping in” differs when performed on primitive activities and when performed on composite activities. For a primitive activity: If a handler is defined on the activity and the handler is invoked, debugger 102 steps to the defined handler; if no handler is defined, performing the step-in is equivalent to stepping over. For a composite activity: If a handler is-defined on the activity, debugger 102 steps to the defined handler; if no handler is defined, then debugger 102 steps to the first executing activity; if no executing activity is present, performing the step-in is equivalent to stepping over. With respect to the composite activity, the debugger 102 may break on whichever of the two (code handler or a child activity) will happen first, which depends on the runtime implementation.

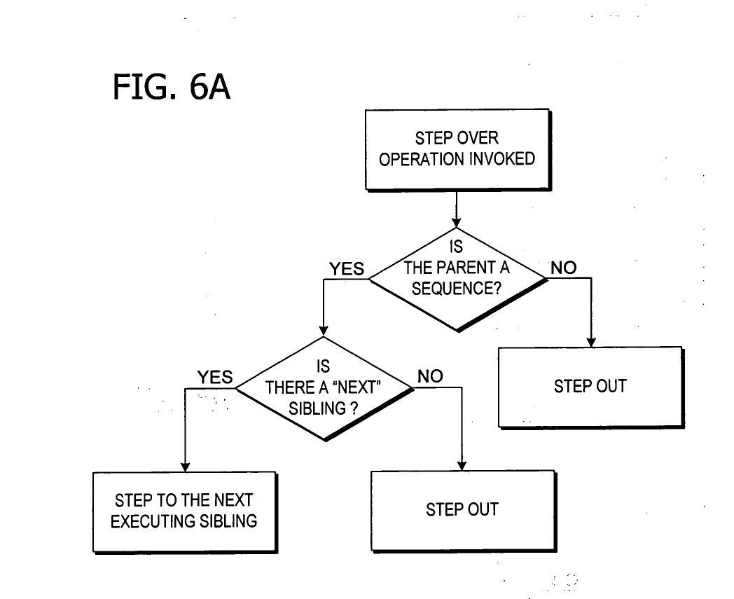

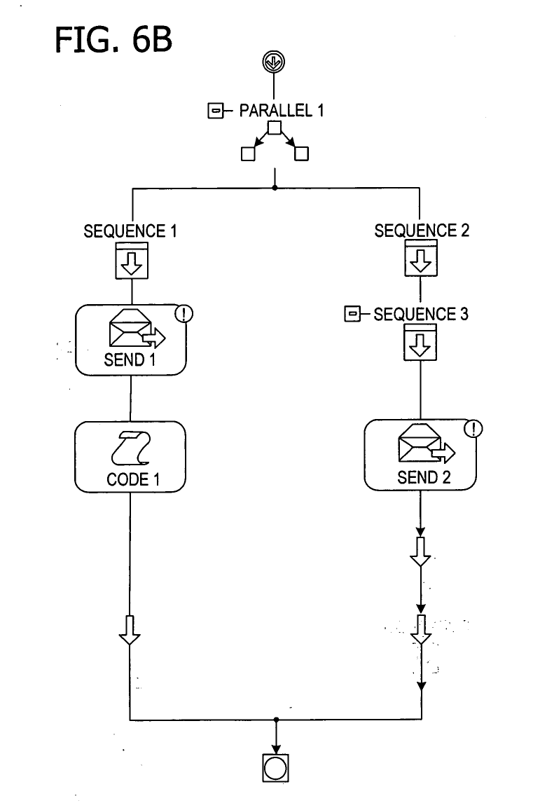

FIG. 6A is an exemplary flow diagram illustrating step-over behavior according to aspects of the invention. Whether an activity is a primitive or a composite, the logic to determine the step-over behavior may be implemented as shown in FIG. 6A. The behavior of stepping out of activities is for the debugger 102 to step to the container of the activity. FIG. 6B is an exemplary-user interface visualization of workflow with stepping according to aspects of the invention. In this example,
Send1: User defined OnBeforeSend Handler called “MySendHandler1”
Code1: User defined Handler called “MyCodeHandler”
Send2: User defined OnBeforeSend Handler called “MYSendHandler2”

The breakpoint may be set on Send1 and the order in which stepping occurs if the developer r chooses to step over is as shown FIG. 6B, where:
Code (developer invokes Step Over)
Sequence1 (developer invokes Step Over)
Parallel1 (developer invokes Step Over)
Schedule1 (Step Over)

In the step-in example, the breakpoint may be set on Send1 and the order in which stepping would occur if the developer chooses to step in is as shown in FIG. 6B, where:
Steps into Send1's “MySendHandler1 ” (developer invokes Step In . . . standard Visual Studio Step-In behavior executes. Ultimately, the debugger steps back into the designer after all the code has been stepped)
Back to Send1 (developer invokes Step In)
Code1 (developer invokes Step In)
Steps into Code1's “MyCodeHandler” (developer invokes Step In . . . standard Visual Studio Step-In behavior executes. Ultimately, the debugger steps back into the designer after all the code has been stepped)
Back to Code1 (developer invokes Step In)
Sequence1 (developer invokes Step In)
Parallel 1 (developer invokes Step In)
Schedule1 (developer invokes Step In)

APPENDIX B is an exemplary representation of the underlying XOML in a XOML view according to aspects of the invention. Thus, debugging is also supported within the XOML editor. The XOML describes the workflow example of FIG. 6B. While debugging, a developer can switch from a workflow designer to a XOML editor as if authoring. Also, when a developer sets a breakpoint in the designer, the corresponding activity within XOML will have a breakpoint set. Setting breakpoints on valid locations within the XOML editor will also set a breakpoint in the designer. Breakpoints are set on activities. Specifically, a breakpoint will be placed on the opening tag of an activity starting from the first character of the activity to the last quote. Breakpoints can be set during authoring. Stepping is also supported when debugging in XOML. The behavior is no different than when debugging in the designer.

APPENDIX C provides an example of “navigation” of workflows within a debugging context.

Aspects of the present invention also support remote debugging where a user connects to a workflow process on a remote machine and may debug it remotely. For instance, the debuggee (i.e., workflow 112) makes available the location of the assemblies housing the workflow and the debugger 102 specifies the location in a Tools→Options→Debugging→Workflow property page. As shown in FIG. 1, a phantom line indicates debugger components of the exemplary architecture that may be located remotely for implementing remote debugging according to an embodiment of the invention. Aspects of the present invention also support an “edit and continue” feature in which activities and/or business logic may be injected into the process to view side effects for invasively modifying the process.

In one embodiment, debugger 102, via designer 110, displays user variables in watch windows and allows the user to view and change the values of the variables. For supporting watches, aspects of the invention overcome a cross process reader-writer problem where one of the processes could enter the break mode at any point in time without blocking the other process. A computer-readable medium includes computer-executable instructions implementing break safe synchronization according to the embodiment described below.

In the workflow, debugger data accessed by the workflow debug engine 102 and the debug controller 118 should be synchronized. The debug engine 102 runs in process with an external development tool suite, for example, and the controller component runs in process with the debugee process 112. The controller 118 may read or write the data and may also request debug engine 102 to break execution at any point. Only when execution is broken may debug engine 102 in turn read or write the data in this embodiment. While debug engine 102 accesses the data, execution is prohibited from resuming. Regular OS synchronization primitives like critical sections and semaphores are not used because if the execution breaks when controller 118 has acquired a lock, the debug engine 102 will deadlock (also causing the development tools UI to hang).

A scheme for solving this break-safe synchronization problem is described in greater detail below. In one embodiment, access to the data by different controller threads can be serialized using appropriate OS synchronization primitives because all controller threads reside in the debugee process 112. In this instance, there is a single debug engine thread that accesses the data. Consequently, the synchronization problem may be reduced to that of a reader/writer problem between a single controller thread and a single debug engine thread. For the purposes of the analysis, it should also be noted that the common language runtime (CLR) ensures that reading or setting the values of variables is atomic and that single instruction write/write or read/write races for variables will not cause any exception or inconsistencies.

With respect to the reader problem, data versioning maintains consistency. In one embodiment, almost identical reader algorithms embodying aspects of the invention may be executed for the debug engine 102 and the controller 118. A CurrentData variable refers to the current versions of the data object. When a reader wants to access the data, it copies the reference to the LocalData variable. The access to CurrentData to do the assignment is exactly one IL instruction LdFld. Since the access is for only one instruction, the CLR ensures that neither will execution break nor will any inconsistencies arise due to read/write races (to the CurrentData variable) while the reference is being copied. Further, in a corresponding writer algorithm, no writer will update the object referred to by CurrentData. Any updates made will be done on a clone of the data object. This ensures that while the data is being read, it will not be modified and will remain consistent. Readers are bound to the version of the data object that was the latest when they first accessed it.

An exemplary reader algorithm for both controller 118 and debug engine 102 follows:

1 If(is Controller) Lock(SerializeDCThreadsMutex);
2 // Access to CurrentData is exactly 1 instruction - LdFld.
3 LocalData = CurrentData; // Reference assignment!
4 Read(LocalData);
5 If(is Controller) Unlock(SerializeDCThreadsMutex);

The writer algorithm according to an embodiment of the invention is different for the controller thread and the debug engine thread. The underlying concept is that the controller thread will clone the data object, update the clone, and save it back to CurrentData. If debug engine 102 wants to modify the data object, it will either do so on the controller's clone (if one exists and the update has been completed by debug controller 118) or it will create a clone of its own, apply the controller changes in addition to its own changes and notify controller 118 to ignore its updated. The algorithm maintains two synchronization state flags flgnoreDCUpdate and fDCDataReady which are both initialized to False when the program starts.

An exemplary writer algorithm for controller 118 follows:

1 Lock(SerializeDCThreadsMutex);
2 fIgnoreDCUpdate = False;
3 ControllerUpdate = update object; // StFld
4 ClonedDCData = Clone(CurrentData);
5 Update(ClonedDCData);
6 fDCDataReady = True;
7 ControllerUpdate = null;
8 If(fIgnoreDCUpdate == False)
9 CurrentData = ClonedDCData;
10 EndIf
11 fDCDataReady = False;
12 Unlock(SerializeDCThreadsMutex);

An exemplary writer algorithm for debug engine 102 follows:

1 If(fDCDataReady && !fIgnoreDCUpdate)
2 Update(ClonedDCData);
3 Else
4 fIgnoreDCUpdate = True;
5 ClonedDEData = Clone(CurrentData);
6 Apply any ControllerUpdate;
7 Clear ControllerUpdate;
8 Update(ClonedDEData);
9 CurrentData = ClonedDCData;
10 EndIf

The logic is relatively simpler on the debug engine thread because the controller thread is prohibited from running while the debug engine thread is running. If controller 118 has not set fDCDataReady to True on line 6, indicating that the cloned data object (referred by the ClonedDCData variable) has been updated and is consistent, debug engine 102 will clone the current data object (referred to by the CurrentData variable). If a controller call was in progress, it will save its updates in ControllerUpdate on line 3, which also must be a one instruction reference assignment (StFld in this instance). The debug engine 102 will then apply the controller's updates to the clone on line 6, followed by its own updates on line 7, and save the cloned object back to the CurrentData variable on line 8. It will also set the flgnoreDCUpdate flag,indicating to the controller 118 that its updates are to be discarded. However, if controller 118 has set fDCDataReady to True, debug engine 102 will update the controller's clone on line 2 and return except if in a previous update the debug engine 102 had made its own clone on line 5, in which case debug engine 102 will continue to make another clone and update it.

In one embodiment of the controller thread, the values of the two synchronization state flags flgnoreDCUpdate and fDCDataReady govern what the controller thread does. After line 2, fDCDataReady will always be False because only a controller thread can set it to True and the controller thread always sets it to False before returning at line 10. The variable flgnoreDCUpdate will be False if debug engine 102 has not updated the data or True if debug engine 102 has updated the data (and set the flag to True on line 4). Given the above, it may appear that the assignment of False to flgnoreDCUpdate at line 2 is unnecessary. However, the assignment serves as a way of clearing the flag in the next controller access once it has been set to True by the debug engine 102.

Lines 3-6 proceed without any influence of the state flags. After line 6, fDCDataReady will be True and flgnoreDCUpdate will be False if debug engine 102 has not updated the data, or True if debug engine 102 has updated the data (and set the flag to True on line 4) as mentioned above.

Line 7 clears the ControllerUpdate reference variable. The point to note is that fDcDataReady is now true and so after line 6, the debug engine 102 will not look at the value of the ControllerUpdate variable.

Lines 8-9 represent a classic test-and-set in the algorithm. After line 6, the value flgnoreDCUpdate (whether True or False) cannot change since the debug engine 102 will not go down the else part of the condition on line 1. Hence, the test-and-set will result in consistent behavior since the flag cannot change to True once it is evaluated to False on line 8. Also, if line 9 is executed, any debug engine updates will already have been made to the controller's clone on line 2.

Between Lines 9 and 11, fDCDataReady will always be True and debug engine updates will be applied to the controller's clone on line 2. This will still result in correct behavior because the reference to the controller's clone stored in variable ClonedDCData is the same as the reference stored in variable CurrentData. This seems to break the reader premise that a writer will not modify the object referred to by CurrentData, however, since there is only ever one debug engine thread (which is in the process of writing) and one controller thread (which is in the process of writing at this point), there can be no reader threads which are affected.

After line 10, the debug engine 102 will resume making its own clone and updating it.

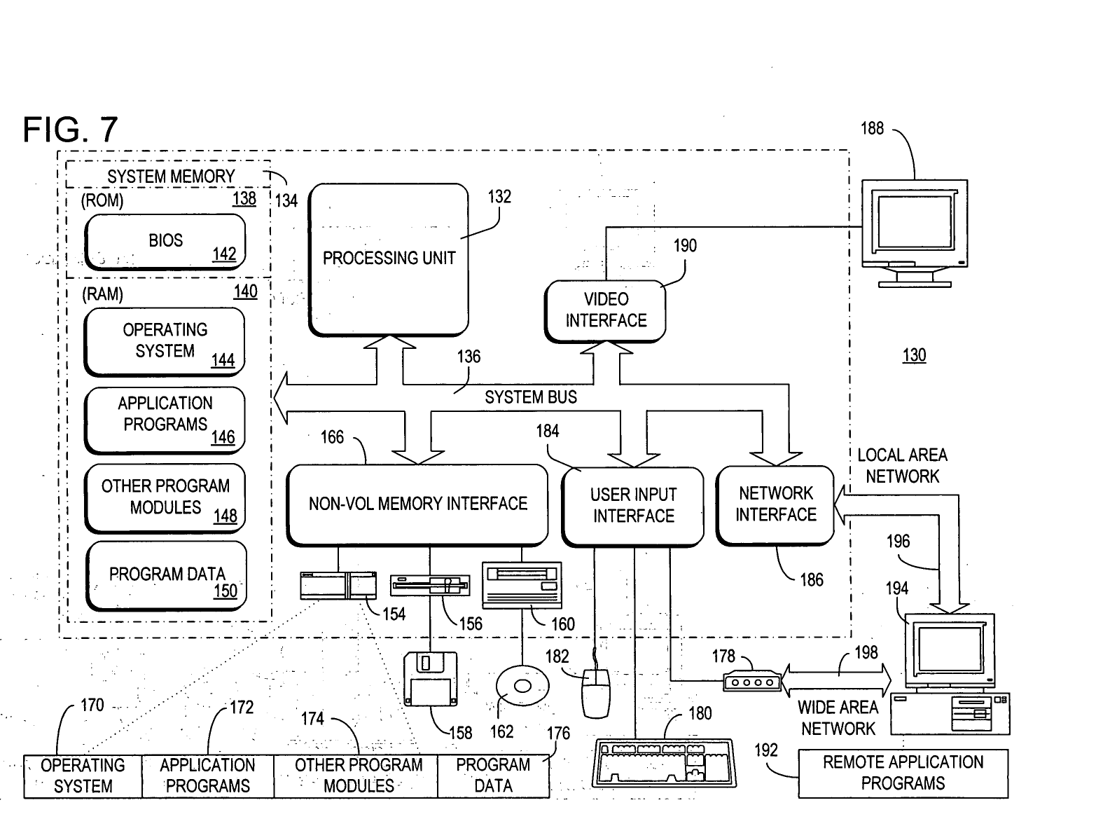

FIG. 7 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has, one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), including the basic routines that help to transfer information between elements within computer 130, such as during start-up, is typically stored in ROM 138. RAM 140 typically includes data and/or program modules that are immediately accessible to and/or presently being operated on by processing unit 132. By way of example, and not limitation, FIG. 7 illustrates operating system 144, application programs 146, other program modules 148, and program data 150.

The computer 130 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 130. In FIG. 7, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard and 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 7 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 7 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Embodiments of the invention described herein include these and other various types of computer-readable storage media when such media include instructions or programs for implementing the steps described below in conjunction with a microprocessor or other data processor. One embodiment of the invention also includes the computer itself when programmed according to the methods and techniques described herein.

For purposes of illustration, programs and other executable program components, such as the operating system, are illustrated herein as discrete blocks. It is recognized, however, that such programs and components reside at various times indifferent storage components of the computer, and are executed by the data process or(s) of the computer.

Although described in connection with an exemplary computing system environment, including computer 130, one embodiment of the invention is operational with numerous other general purpose or special purpose computing system environments or configurations. The computing system environment is not intended to suggest any limitation as to the scope of use or functionality of embodiments of the invention. Moreover, the computing system environment should not be interpreted as having any dependency or requirement relating to any one or combination of components illustrated in the exemplary operating environment. Examples of well known computing systems, environments, and/or configurations that maybe suitable for use with the embodiments of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include but are not limited to, routines, programs, objects, components, and data structures that perform particular tasks or implement particular abstract data types. Embodiments of the invention may also be practiced in distributed computing environments where tasks are performed by remote processing devices that are linked through a communications network. In a distributed computing environment, program modules may be located on both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication):, and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation according to one embodiment of the invention, computer 130 executes instructions for debugging a workflow written with a workflow design tool. The computer 130 implements layered on top of a development tool debugging framework 104 for setting one or more debugging breakpoints directly on the workflow activities. Execution of the workflow stops at each of the breakpoints and computer 130 displays the state of the activity at the breakpoint at which the workflow stops execution. The debug engine 102 extracts at least a portion of source code of the workflow for debugging the workflow at the source code level and can be attached to a running instance of the workflow.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As various changes could be made in the above constructions and methods without departing from the scope of embodiments of the invention, it is intended that all matter contained in the above description and shown in the accompanying drawings shall be interpreted as illustrative and not in a limiting sense.

### Appendix A

Attaching to Process and Window Integration: This exemplary scenario describes a walkthrough of a developer connecting to a process that hosts a workflow. The walkthrough describes a new debug window called “workflows” and the integration that we plan to expose between this new window and the integrated Visual Studio® Breakpoint, Process, Threads and Call Stack Windows.

Elvis has just finished writing his first workflow and wants to see how it would work when it goes into production. He built it against a workflow services host and is now ready to do a trial run and make sure that the output he expects will actually occur. The workflow has been deployed, associated with a document library and it has started running waiting for the first step to execute.

Elvis starts up a development suite, such as Microsoft's Visual Studio®, and loads his solution from his hard drive. From the Tools menu, he selects Attach to Process. In the “Attach To” code types, he selects “Workflow”. In this example, the development suite's debugging environment or framework opens. He navigates to the Debug menu and selects “Break All”. In addition to the Breakpoint, Processes, Threads and Call Stack, Elvis is presented with a “Workflows” window. Elvis is very familiar with debugging applications and decides to investigate the new “Workflows” windows before drilling into with each of the framework's debugging windows.

Elvis selects the workflow window and it displays all the currently loaded/executing workflows within the specified host. Drilling into the workflow he created (CreateMoraleEvent), he sees that there is one instance available for him to select. When he expands the node describing the instance, he sees a tree representation of his workflow.

Elvis decides to use the framework's windows and explore what other new features the Workflow debugger offers. Elvis had not set any breakpoints within his workflow yet. Thus, when he clicks on the breakpoint window tab as he expects, he finds that the window has not been populated. When Elvis clicks on the Processes Window, he sees that the process he selected is displayed in the Process List. For now, he only attaches to one process. However, he could attach to others. The Workflow window would be updated with any workflows selected in that process. Elvis clicks into the threads window and notices that provides a list of all the threads currently executing the workflow instance. When Elvis double clicks on a thread, the Workflows window is brought into focus and the activity currently being executed by the thread is selected.

Elvis is starting to feel comfortable with the new workflow debugger and decides to drill further into the new “Workflows” debugging window. Elvis clicks back into the “Workflows” window and notices that it displays all the currently loaded/executing workflows within the specified host. Drilling into the workflow he created (CreateMoraleEvent), he sees that there is one instance available for him to select. When he expands the node describing the instance, he sees the tree representation of his workflow. He double clicks on the instance and the workflow is loaded into his designer.

Elvis notices that the visualization of the workflow has changed. Currently executing activities are yellow and activities which have yet to execute are appear unchanged. Elvis had played with the Theme feature of the designer and associates this with a built in “debugging theme”. Elvis now begins to impersonate the people he would expect to participate in this workflow. First, he pretends to be the event submitter. He switches into InfoPath and submits the Moral Event Request form to the document library with an event cost value that he expects the workflow to accept.

Elvis puts on his developer hat again and switches back into the development suite of tools. The designer has updated the visualization of the workflow and the previously gray “BookFacility” activity is now colored. The Workflow window has been updated and he notices that the ScheduleMoralEvent Instance he has selected now displays “BookFacility” as a child node. He switches to his Task Library within Sharepoint and sees as expected that a task requesting him to book a facility has been created. He pretends that he called the requested facility and updates the task to indicate that the Facility has been successfully booked. Finally, he switches to his email program and sees that an email with a facility booking confirmation has been delivered.

Now back into the development suite, he sees that the workflow has been unloaded and that he is back to the authoring environment he used to create the workflow. Elvis decides to open up another workflow and use the breakpoint functionality exposed in the workflow debugger. Conceptually, interactions with the external systems are pseudo breakpoints. That is, the workflow has stopped executing at the point where it requires input from the user.

Before entering into debug mode, Elvis selects an activity and sets a breakpoint by using the “Set Breakpoint” option in the Workflow menu. He deploys his workflow and as he did previously, attaches to the host process. The workflow executes as expected until the execution processes to the activity with the set breakpoint. At this point, the debugger themed designer loads and sets focus on the activity with the set breakpoint.

APPENDIX B
XOML View

```
<Schedule TransactionType=“None” Retriable=“False”
Synchronized=“False” IsolationLevel=“Unspecified”
Timeout=“30” Batchable=“False”
ClassName=“WorkflowApp.Schedule1”
ID=“Schedule1”>
  <Receive Message=“*Bind(DataSource={msg1})” Activation=“True”
ID=“receive1”>
    <Receive.TypedChannel>
      <TypedChannel Channel=“*Bind(DataSource={ChanIn})”
    Operation=“Send” />
    </Receive.TypedChannel>
  </Receive>
  <Send Message=“*Bind(DataSource={msg1})” ID=“send1”>
    <Send.TypedChannel>
      <TypedChannel Channel=“*Bind(DataSource={ChanOut})”
    Operation=“Send” />
    </Send.TypedChannel>
  </Send>
  <Parallel ID=“parallel1”>
    <Sequence ID=“sequence1”>
      <Code UserCodeHandler=“{Code1Handler}” ID=“code1” />
    </Sequence>
    <Sequence ID=“sequence2”>
      <Code UserCodeHandler=“{Code2Handler}” ID=“code2” />
    </Sequence>
  </Parallel>
</Schedule>
```

### Appendix C

Navigation of workflows within a debugging context is primarily contingent on locating the XOML file and ensuring its consistency with the XOML extracted from the hosting process. In order to best explain the scenarios, it is easiest to break them into two categories: “XOML Consistent & Found” and “XOML Not Found”.

“XOML Consistent and Found”—Elvis is running his new application, which is hosting a workflow. He opens a new instance of a development tools suite, such as Microsoft's Visual Studio®, and opens the solution he used to create the application and the workflow. He then selects “Attach to Process” from the Tools menu and selects the host executable. He selects “Break All” from the debug menu. He sees that the calls stack provides him an instance of his workflow and he double clicks to open it. The XOML file is opened from his project and he proceeds to debug his workflow.

“XOML Not Found”—Elvis is running his new application, which is hosting a workflow. Elvis does not have a copy of the solution used to create the workflow on his machine. He opens a new instance of the developer suite and selects “Attach to Process” from the Tools menu and selects the host executable. He selects “Break All” from the debug menu and sees that the threads provide him an instance of his workflow and he double clicks to open it. A new empty Solution is created by Visual Studio® and Schedule1.xoml is added to “Miscellaneous Files” folder of the new solution. The XOML file is opened from this project and he proceeds to debug his workflow.

In the scenarios above, the key difference is that Elvis had an existing copy of the schedule definition on his machine (he happened to open it directly in the first scenario) in the first scenario. In the second scenario, no definition of the schedule existed locally. Both scenarios are supported.

Two behaviors of opening a workflow within this scenario are supported, namely, the developer has opened the project used to author the workflow and the developer can attach to a workflow process without having the project used to author the workflow open. Irrespective of which mechanism is used to open the workflow, the file that is retrieved by the designer is found locally in pre-defined locations and the checksum of the file and the XOML retrieved from the host process match. If these two conditions are met, then navigation occurs based on the local file which was found. All navigation from the Breakpoint, Call Stack, or Threads windows is performed against the locally found file.

The search for file proceeds in the following order:
Within the existing solution In the Debug Source Paths specified within Solution Properties (Common Properties→Debug Source Files).

The search works by looking for an attribute ([Microsoft.Workflow.ComponentModel.XomlSourceAttribute]) stored within the hidden partial class during compilation. In order to correctly navigate, editors within the framework use the combination of line and column. However, the goal is to provide navigation for the workflow designer which doesn't represent its surface as a line/column matrix. In order to do this, a mapping between line/column location and activity placement within the workflow designer must be maintained.

A checksum ensures that the XOML file which was found locally matches the XOML retrieved from the host and that this mapping is correct. This implies that if the host workflow has changed (via a Dynamic Update) or the local file has changed before debugging begins, the checksum will not match and the, behavior expected would fit in the “XOML Not Found” category. However, if the developer changes the XOML file after the file has been found and the checksums match, navigation may not work as expected. If the line does not exist in the file, navigation proceeds to the closest line. If the attempt to locate the local file fails or the checksum of the XOML file is different from that retrieved from the host process, then the scenario fits into the “XOML Not Found” category described below.

The “XOML Not Found” scenario covers the cases where the checksum of the XOML locally and in the host process do not match. Implicitly, if no XOML file is found, this means that the checksum is zero and thus would fall into this category. When this occurs, navigation occurs based on the XOML retrieved from the host process. The XOML retrieved from the host process will not provide any of the user code defined by the developer unless the framework finds the corresponding C#/VB files and PDBs. That is to say, it will only provide the XOML and not include any C# or VB code (variables, handlers etc).

When a workflow undergoes a dynamic update before the debugging session begins, the debugger will behave the same as in “XOML Not Found”. If the code corresponding to workflow can be found locally then it will be used for debugging. If a workflow undergoes a dynamic update after the debugging session begins, the debugger syncs up the dynamic update event from the runtime, and updates schedule type information immediately but the XOML file will be updated when a breakpoint would get hit or user would break the process.

What is claimed is:

1. A computerized method of debugging a workflow, said workflow having a plurality of activities, each of said activities having a state during execution of the workflow, said method comprising:
setting one or more debugging breakpoints directly on the workflow activities;
stopping execution of the workflow at each of the breakpoints; and
displaying the state of the activity at the breakpoint at which the workflow stops execution.

2. The method of claim 1, wherein the workflow is written with a workflow design tool and further comprising integrating the design tool with a debug engine for debugging the workflow.

3. The method of claim 2, further comprising extracting at least a portion of source code of the workflow with the debug engine.

4. The method of claim 3, further comprising debugging the workflow at the source code level.

5. The method of claim 2, further comprising layering the debug engine on top of a development tool debugging framework.

6. The method of claim 2, wherein the debug engine includes one or more of the following tools: a thread window, a call stack window, a breakpoint window, an immediate statement evaluation window, and a watch window.

7. The method of claim 2, further comprising extracting, with the debug engine, process logic of the workflow corresponding to underlying source code.

8. The method of claim 1, further comprising attaching a workflow debug engine to a running instance of the workflow.

9. The method of claim 1, further comprising connecting to the workflow via a remote computer to remotely debug the workflow.

10. The method of claim 1, further comprising injecting one or more activities into the workflow to view process changes resulting from the injected activities.

11. The method of claim 1, wherein one or more computer-readable media have computer-executable instructions for performing the method recited in claim 1.

12. A computer-readable medium having computer-executable instructions for debugging a workflow, said workflow having a plurality of activities, each of said activities having a state during execution of the workflow, said computer-readable medium comprising:
a debug engine for debugging the workflow, said debug engine being integrated with an external debugging framework and running in process therewith;
a debug controller for controlling the debug engine, said debug controller running in process with the workflow; said debug controller comprising a breakpoint component for stopping execution of the workflow at one or more breakpoints set on the workflow activities;
a reader component for reading a data object representing the state of the workflow activity at one of the breakpoints; and
a writer component for writing updates to the data object for synchronizing the debug engine and the debug controller.

13. The computer-readable medium of claim 12, wherein debug controller threads reside with the workflow and debug engine threads reside with the external debugging framework.

14. The computer-readable medium of claim 13, wherein the debug controller threads and the debug engine threads are prohibited from running simultaneously.

15. The computer-readable medium of claim 12, wherein the debug controller and the debug engine are prohibited from modifying the data object directly.

16. The computer-readable medium of claim 12, wherein the debug controller creates a clone of the data object, updates the clone, and saves the updated clone as the data object.

17. A computerized method of debugging a workflow, said workflow being written with a workflow design tool and having a plurality of activities, each of said activities having a state during execution of the workflow, said method comprising:
integrating the design tool with a debug engine for debugging the workflow
extracting at least a portion of source code of the workflow with the debug engine; and
debugging the workflow at the source code level.

18. The method of claim 17, further comprising setting one or more debugging breakpoints directly on the workflow activities and stopping execution of the workflow at each of the breakpoints.

19. The method of claim 17, further comprising displaying the state of the activity at the breakpoint at which the workflow stops execution.

20. The method of claim 17, further comprising layering the debug engine on top of a development tool debugging framework.
